(19) United States
(12) Patent Application Publication
(10) Pub. No.: US 2026/0154504 A1
(43) Pub. Date: Jun. 4, 2026

(54) SYSTEMS AND METHODS FOR AUTOMATED ASSESSMENT OF MEDIA CONTENT FOR SINCERITY

(71) Applicant: Y2 Consulting LLC, Hollywood, FL (US)

(72) Inventors: Jonathan Blumenthal, Hollywood, FL (US); Daniel Winnick, Pikesville, MD (US)

(73) Assignee: Y2 Consulting LLC, Hollywood, FL (US)

(21) Appl. No.: 19/177,346

(22) Filed: Apr. 11, 2025

Related U.S. Application Data
(60) Provisional application No. 63/633,162, filed on Apr. 12, 2024.

(51) Int. Cl. G06F 40/284; G06F 40/30

(52) U.S. Cl. CPC G06F 40/284; G06F 40/30

(57) ABSTRACT

A non-transitory computer-readable medium storing instructions that, when executed by a processor, cause a system to perform a method for analyzing media content, the method comprising: ingesting, via one or more web scraping techniques, media content from one or more online sources; preprocessing, via one or more natural language processing tools, the media content comprising the steps of: tokenizing the media content into a plurality of components, removing stop words from the plurality of components, lemmatizing the plurality of components, and normalizing the plurality of components; analyzing, via the one or more natural language processing tools, the preprocessed media content for one or more sentiments; generating, via one or more scoring algorithms, a score for each of the one or more sentiments; compiling the score for each of the one or more sentiments to generate a final score; and displaying the final score on one or more client devices.

### CROSS REFERENCE TO RELATED APPLICATIONS

The present application claims the benefit of U.S. Patent Application No. 63/633,162 for SYSTEMS AND METHODS FOR AUTOMATED ASSESSMENT OF MEDIA CONTENT FOR SINCERITY, filed Apr. 12, 2024, the entire contents of which are incorporated herein by reference.

### FIELD OF THE PRESENT DISCLOSURE

The present disclosure is directed to systems and methods for automated assessment of media content for sincerity. More specifically, the present disclosure is directed towards systems and methods for automated assessment of media content for sincerity via scoring one or more metrics of media derived from various sources.

### INTRODUCTION

In today's digital era, the global populace enjoys unprecedented access to information facilitated by the internet. While the internet has played a pivotal role in democratizing the accessibility of information, a pervasive issue looms large-misinformation. Propelled by the swift dissemination of content across an array of online platforms, notably social media, misinformation emerges as a formidable threat to society. Because the internet facilitates instantaneous circulation of information around the globe, it is a fertile ground for the rapid propagation of misinformation. Particularly noteworthy is the emergence of social media platforms, which serve as formidable factories for misinformation.

The ramifications of misinformation extend well beyond the realm of influencing individual perspectives; its impact resonates across broader spectrums, such as, shaping public opinion, influencing political landscapes, and even contributing to the exacerbation of social conflicts. False narratives spawned by misinformation can lead to misguided decisions, which in turn contribute to the erosion of a well-informed and discerning society.

Addressing the challenges posed by misinformation in the digital age is of paramount importance. Currently, methods employed by individuals to assess the integrity of their information sources are laborious; oftentimes requiring large investments of time thoroughly investigating a topic, to ensure the information source is reliable. Such a time investment is impractical for those leading busy lifestyles, thereby elevating the likelihood one falls prey to misinformation.

Accordingly, it would be desirable to provide systems and methods capable of assessing the integrity of media derived from a wide range of sources. Moreover, it would also be desirable to provide systems and methods able to assign an integrity score to the media, thus offering a quantifiable measure of its trustworthiness. Furthermore, it would be desirable to implement systems and methods furnishing such an integrity score in real-time, contemporaneously with the broadcast of the media.

### SUMMARY

This Summary is provided to introduce a selection of concepts in a simplified form that are further described below in the Detailed Description. This Summary is not intended to identify key features or essential features, nor is it intended to limit the scope of the claims included herewith.

Aspects of the present disclosure may relate to a non-transitory computer-readable medium storing instructions that, when executed by a processor, cause a system to perform a method for analyzing media content. In an embodiment, the method may be comprised of ingesting, via one or more web scraping techniques, media content from one or more online sources; preprocessing, via one or more natural language processing tools, the media content comprising the steps of: tokenizing the media content into a plurality of components, removing stop words from the plurality of components, lemmatizing the plurality of components, and normalizing the plurality of components; analyzing, via the one or more natural language processing tools, the preprocessed media content for one or more sentiments; generating, via one or more scoring algorithms, a score for each of the one or more sentiments; compiling the score for each of the one or more sentiments to generate a final score; and displaying the final score on one or more client devices.

In an embodiment, the one or more natural language processing tools may be comprised of at least one of NLTK and spaCy.

Furthermore, the one or more web scraping techniques may include Python-based scraping tools. Moreover, the one or more web scraping techniques may include JavaScript-based scraping tools.

In another embodiment, the method may further comprise performing, via the one or more natural language processing tools, semantic analysis on the preprocessed media content. Yet further, the method may additionally comprise normalizing, via one or more statistical analysis libraries, the score for each of the one or more sentiments.

In a further embodiment, the one or more statistical analysis libraries may be comprised of Python libraries including pandas, NumPy, SciPy, and SQLAlchemy.

In yet a further embodiment, compiling the score for each of the one or more sentiments may be accomplished via one or more database management systems.

Aspects of the present disclosure may relate to a non-transitory computer-readable medium storing instructions that, when executed by a processor, cause a system to perform a method for analyzing audio content, the method comprising: ingesting, via one or more web scraping techniques, audio content from one or more online sources; preprocessing, the audio content comprising the steps of: filtering background noise out of the audio content, segmenting the filtered audio content into a plurality of segments, transcribing the plurality of segments into text, tokenizing the text into a plurality of components, removing stop words from the plurality of components, lemmatizing the plurality of components, and normalizing the plurality of components; analyzing, via one or more natural language processing tools, the preprocessed audio content for one or more sentiments; generating, via one or more scoring algorithms, a score for each of the one or more sentiments; compiling the score for each of the one or more sentiments to generate a final score; and displaying the final score on one or more client devices.

In an embodiment, the one or more natural language processing tools are comprised of at least one of NLTK and spaCy.

In an embodiment, the one or more web scraping techniques include Python-based scraping tools.

In an embodiment, the one or more web scraping techniques include JavaScript-based scraping tools.

In an embodiment, the method further comprises: performing, via the one or more natural language processing tools, semantic analysis on the preprocessed audio content.

In an embodiment, the method further comprises: normalizing, via one or more statistical analysis libraries, the score for each of the one or more sentiments.

In an embodiment, the one or more statistical analysis libraries are comprised of Python libraries including pandas, NumPy, SciPy, and SQLAlchemy.

In an embodiment, compiling the score for each of the one or more sentiments is accomplished via one or more database management systems.

In an embodiment, transcribing the plurality of segments into text is accomplished via at least one of Google Speech-to-Text and IBM Watson Speech to Text.

In an embodiment, when executed by a processor, a system may perform a method for analyzing media content, the method comprising: ingesting, via one or more web scraping techniques, media content from one or more online sources; preprocessing, via one or more natural language processing tools, the media content comprising the steps of: tokenizing the media content into a plurality of components, removing stop words from the plurality of components, lemmatizing the plurality of components, and normalizing the plurality of components; analyzing, via the one or more natural language processing tools, the preprocessed media content for one or more sentiments; evaluating, via a logic-structure evaluation module, the preprocessed media content to identify premises, conclusions, and inferential transitions; computing a logical coherence score based on structural consistency and alignment with formal logic schemas; generating, via one or more scoring algorithms, a sentiment score for the one or more sentiments; integrating the logical coherence score and the sentiment score to produce a combined integrity score; generating a visualization of the analyzed media content, wherein the visualization may include at least one of a logic graph and a breakdown of emotional and logical content; and displaying the combined integrity score and the visualization on one or more client devices.

In an embodiment, evaluating the preprocessed media content via the logic-structure evaluation module comprises: employing a combination of rule-based systems and machine learning models, wherein the machine learning models include at least one of discourse marker analysis, syntactic parsing, semantic role labeling, coreference resolution, argument mining, sequence labeling, and transformer-based models; and constructing a graph representation of an argument structure, wherein nodes represent statements and edges represent logical relationships.

In an embodiment, the method further comprises: analyzing, via the logic-structure evaluation module, a series of media content from a single source over a predetermined time period; identifying logical inconsistencies within the series of media content by comparing logical structures and conclusions across different time points; generating a temporal consistency score that quantifies the degree of logical consistency and inconsistency over the predetermined time period; integrating the temporal consistency score with the combined integrity score to produce a longitudinal integrity assessment; and displaying the longitudinal integrity assessment on the one or more client devices, including a visualization of how logical consistency changes over time.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 illustrates an embodiment of an environment in which the present disclosure may be practiced.

FIG. 2 illustrates an embodiment of a block diagram of an electronic device.

FIG. 3 is an illustration of an embodiment of a system for automated assessment of media content for sincerity.

FIG. 4 is an illustration of a block diagram of a method for automated assessment of media content for sincerity.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

It is noted that description herein is not intended as an extensive overview, and as such, concepts may be simplified in the interests of clarity and brevity.

All documents mentioned in this application are hereby incorporated by reference in their entirety. Any process described in this application may be performed in any order and may omit any of the steps in the process. Processes may also be combined with other processes or steps of other processes.

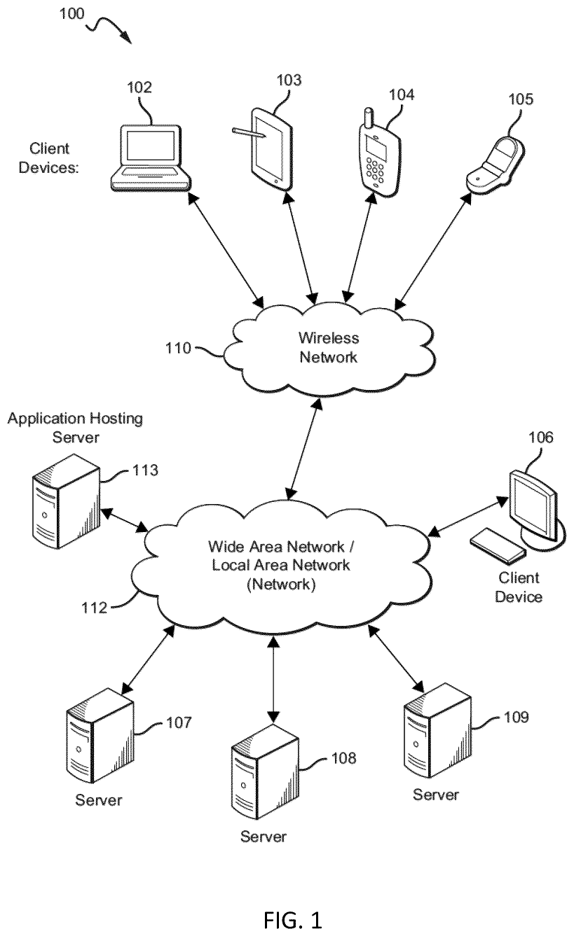

FIG. 1 illustrates components of one embodiment of an environment in which the present disclosure may be practiced. Not all of the components may be required to practice the present disclosure, and variations in the arrangement and type of the components may be made without departing from the spirit or scope of the present disclosure. As shown, the system 100 includes one or more Local Area Networks (“LANs”)/Wide Area Networks (“WANs”) 112, one or more wireless networks 110, one or more wired or wireless client devices 106, mobile or other wireless client devices 102-105, servers 107-109, and may include or communicate with one or more data stores or databases. The client devices 102-106 may include, for example, at least one of desktop computers, laptop computers, set top boxes, tablets, cell phones, smart phones, smart speakers, wearable devices (such as the Apple Watch) and the like. Servers 107-109 can include, for example, one or more application servers, content servers, search servers, and the like. FIG. 1 also illustrates application hosting server 113.

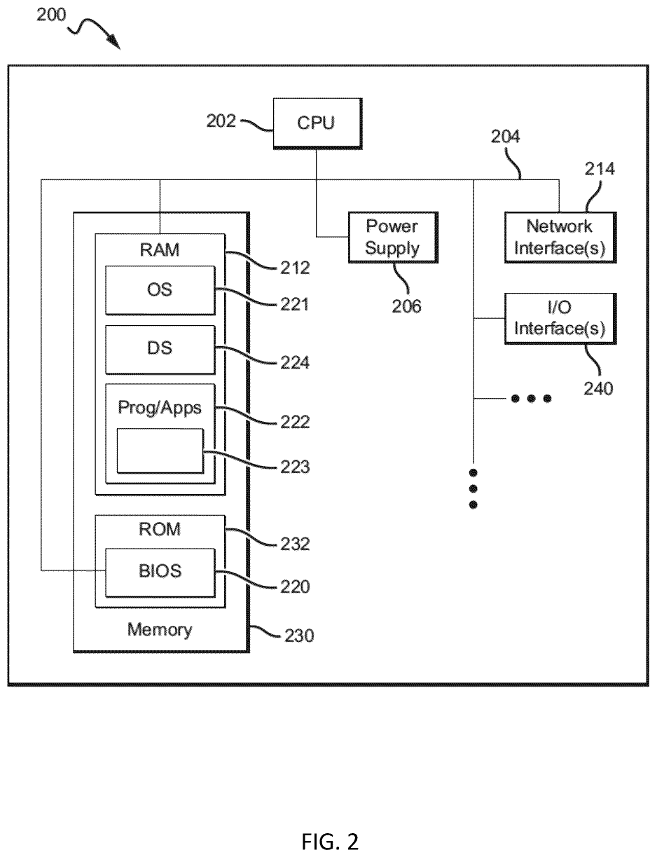

FIG. 2 illustrates a block diagram of an electronic device 200 that can implement one or more aspects of an apparatus, system, and method for automated assessment of media sincerity (the “Engine”) according to one embodiment of the present disclosure. Instances of the electronic device 200 may include servers, e.g., servers 107-109, and client devices, e.g., client devices 102-106. In general, the electronic device 200 can include a processor/CPU 202, memory 230, a power supply 206, and input/output (I/O) components/devices 240, e.g., microphones, speakers, displays, touchscreens, keyboards, mice, keypads, microscopes, GPS components, cameras, heart rate sensors, light sensors, accelerometers, targeted biometric sensors, etc., which may be operable, for example, to provide graphical user interfaces or text user interfaces.

A user may provide input via a touchscreen of an electronic device 200. A touchscreen may determine whether a user is providing input by, for example, determining whether the user is touching the touchscreen with a part of the user's body such as his or her fingers. The electronic device 200 can also include a communications bus 204 that connects the aforementioned elements of the electronic device 200. Network interfaces 214 can include a receiver and a transmitter (or transceiver), and one or more antennas for wireless communications.

The processor 202 can include one or more of any type of processing device, e.g., a Central Processing Unit (CPU), and a Graphics Processing Unit (GPU). Also, for example, the processor can be central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software-controlled microprocessor, discrete logic, e.g., an Application Specific Integrated Circuit (ASIC), a programmable/programmed logic device, memory device containing instructions, etc., or combinatorial logic embodied in hardware. Furthermore, logic may also be fully embodied as software.

The memory 230, which can include Random Access Memory (RAM) 212 and Read Only Memory (ROM) 232, can be enabled by one or more of any type of memory device, e.g., a primary (directly accessible by the CPU) or secondary (indirectly accessible by the CPU) storage device (e.g., flash memory, magnetic disk, optical disk, and the like). The RAM can include an operating system 221, data storage 224, which may include one or more databases, and programs and/or applications 222, which can include, for example, software aspects of the program 223. The ROM 232 can also include Basic Input/Output System (BIOS) 220 of the electronic device.

Software aspects of the program 223 are intended to broadly include or represent all programming, applications, algorithms, models, software, and other tools necessary to implement or facilitate methods and systems according to embodiments of the present disclosure. The elements may exist on a single computer or be distributed among multiple computers, servers, devices, or entities.

The power supply 206 contains one or more power components and facilitates supply and management of power to the electronic device 200.

The input/output components, including Input/Output (I/O) interfaces 240, can include, for example, any interfaces for facilitating communication between any components of the electronic device 200, components of external devices (e.g., components of other devices of the network or system 100), and end users. For example, such components can include a network card that may be an integration of a receiver, a transmitter, a transceiver, and one or more input/output interfaces. A network card, for example, can facilitate wired or wireless communication with other devices of a network. In cases of wireless communication, an antenna can facilitate such communication. Also, some of the input/output interfaces 240 and the bus 204 can facilitate communication between components of the electronic device 200, and in an example can case processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the Engine, via a network to another device. Also, an application server 113 may, for example, host a web site that can provide a user interface for administration of example aspects of the Engine.

Any computing device capable of sending, receiving, and processing data over a wired and/or a wireless network 110 may act as a server, such as in facilitating aspects of implementations of the Engine. Thus, devices acting as a server may include devices such as dedicated rack-mounted servers, desktop computers, laptop computers, set top boxes, integrated devices combining one or more of the preceding devices, and the like.

Servers may vary widely in configuration and capabilities, but they generally include one or more central processing units, memory, mass data storage, a power supply, wired or wireless network interfaces, input/output interfaces, and an operating system such as Windows Server, Mac OS X, Unix, Linux, FreeBSD, and the like.

A server may include, for example, a device that is configured, or includes a configuration, to provide data or content via one or more networks to another device, such as in facilitating aspects of an example apparatus, system, and method of the Engine. One or more servers may, for example, be used in hosting a Web site, such as the web site www.microsoft.com. One or more servers may host a variety of sites, such as, for example, business sites, informational sites, social networking sites, educational sites, wikis, financial sites, government sites, personal sites, and the like.

Servers may also, for example, provide a variety of services, such as Web services, third-party services, audio services, video services, email services, HTTP or HTTPS services, Instant Messaging (IM) services, Short Message Service (SMS) services, Multimedia Messaging Service (MMS) services, File Transfer Protocol (FTP) services, Voice Over IP (VOIP) services, calendaring services, phone services, and the like, all of which may work in conjunction with example aspects of an example systems and methods for the apparatus, system and method embodying the Engine. Content may include, for example, text, images, audio, video, and the like.

In example aspects of the apparatus, system and method embodying the Engine, client devices may include, for example, any computing device capable of sending and receiving data over a wired and/or a wireless network. Such client devices may include desktop computers as well as portable devices such as cellular telephones, smart phones, display pagers, Radio Frequency (RF) devices, Infrared (IR) devices, Personal Digital Assistants (PDAs), handheld computers, GPS-enabled devices tablet computers, sensor-equipped devices, laptop computers, set top boxes, wearable computers such as the Apple Watch and Fitbit, integrated devices combining one or more of the preceding devices, and the like.

Client devices such as client devices 102-106, as may be used in an example apparatus, system and method embodying the Engine, may range widely in terms of capabilities and features. For example, a cell phone, smart phone, or tablet may have a numeric keypad and a few lines of monochrome Liquid-Crystal Display (LCD) display on which only text may be displayed. In another example, a Web-enabled client device may have a physical or virtual keyboard, data storage (such as flash memory or SD cards), accelerometers, gyroscopes, respiration sensors, body movement sensors, proximity sensors, motion sensors, ambient light sensors, moisture sensors, temperature sensors, compass, barometer, fingerprint sensor, face identification sensor using the camera, pulse sensors, heart rate variability (HRV) sensors, beats per minute (BPM) heart rate sensors, microphones (sound sensors), speakers, GPS or other location-aware capability, and a 2D or 3D touch-sensitive color screen on which both text and graphics may be displayed. In some embodiments multiple client devices may be used to collect a combination of data. For example, a smart phone may be used to collect movement data via an accelerometer and/or gyroscope and a smart watch (such as the Apple Watch) may be used to collect heart rate data. The multiple client devices (such as a smart phone and a smart watch) may be communicatively coupled.

Client devices, such as client devices 102-106, for example, as may be used in an example apparatus, system and method implementing the Engine, may run a variety of operating systems, including personal computer operating systems such as Windows, iOS or Linux, and mobile operating systems such as iOS, Android, Windows Mobile, and the like. Client devices may be used to run one or more applications that are configured to send or receive data from another computing device. Client applications may provide and receive textual content, multimedia information, and the like. Client applications may perform actions such as browsing webpages, using a web search engine, interacting with various apps stored on a smart phone, sending, and receiving messages via email, SMS, or MMS, playing games (such as fantasy sports leagues), receiving advertising, watching locally stored or streamed video, or participating in social networks.

In example aspects of the apparatus, system and method implementing the Engine, one or more networks, such as networks 110 or 112, for example, may couple servers and client devices with other computing devices, including through wireless network to client devices. A network may be enabled to employ any form of computer readable media for communicating information from one electronic device to another. The computer readable media may be non-transitory. A network may include the Internet in addition to Local Area Networks (LANs), Wide Area Networks (WANs), direct connections, such as through a Universal Serial Bus (USB) port, other forms of computer-readable media (computer-readable memories), or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, optic fiber links, or other communications links known to those skilled in the art. Furthermore, remote computers and other related electronic devices could be remotely connected to either LANs or WANs via a modem and a telephone link.

A wireless network, such as wireless network 110, as in an example apparatus, system and method implementing the Engine, may couple devices with a network. A wireless network may employ stand-alone ad-hoc networks, mesh networks, Wireless LAN (WLAN) networks, cellular networks, and the like.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G) generation, Long Term Evolution (LTE) radio access for cellular systems, WLAN, Wireless Router (WR) mesh, and the like. Access technologies such as 2G, 2.5G, 3G, 4G, 5G, and future access networks may enable wide area coverage for client devices, such as client devices with various degrees of mobility. For example, a wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, and the like. A wireless network may include virtually any wireless communication mechanism by which information may travel between client devices and another computing device, network, and the like.

Internet Protocol (IP) may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPV6. The Internet includes local area networks (LANs), Wide Area Networks (WANs), wireless networks, and long-haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site.

The header of the packet may include, for example, the source port (16 bits), destination port (16 bits), sequence number (32 bits), acknowledgement number (32 bits), data offset (4 bits), reserved (6 bits), checksum (16 bits), urgent pointer (16 bits), options (variable number of bits in multiple of 8 bits in length), padding (may be composed of all zeros and includes a number of bits such that the header ends on a 32 bit boundary). The number of bits for each of the above may also be higher or lower.

A “content delivery network” or “content distribution network” (CDN), as may be used in an example apparatus, system and method implementing the Engine, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's web site infrastructure, in whole or in part, on the third party's behalf.

A Peer-to-Peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Embodiments of the present disclosure include apparatuses, systems, and methods implementing the Engine. Embodiments of the present disclosure may be implemented on one or more of client devices 102-106, which are communicatively coupled to servers including servers 107-109. Moreover, client devices 102-106 may be communicatively (wirelessly or wired) coupled to one another. In particular, software aspects of the Engine may be implemented in the program 223. The program 223 may be implemented on one or more client devices 102-106, one or more servers 107-109, and 113, or a combination of one or more client devices 102-106, and one or more servers 107-109 and 113.

In an embodiment, the system may receive, process, generate and/or store time series data. The system may include an application programming interface (API). The API may include an API subsystem. The API subsystem may allow a data source to access data. The API subsystem may allow a third-party data source to send the data. In one example, the third-party data source may send JavaScript Object Notation (“JSON”)-encoded object data. In an embodiment, the object data may be encoded as XML-encoded object data, query parameter encoded object data, or byte-encoded object data.

The present disclosure relates to systems and methods for automated assessment of media content for sincerity. In an embodiment, the system for automated assessment of media content for sincerity may assign a grade and/or level to a source of information, wherein said grade and/or level may correspond to a calculated value of integrity. For example, the system for automated assessment of media content for sincerity may assign a score of 0 to a low integrity source of information and a score of 10 to a high integrity source of information. Further, the system for automated assessment of media content for sincerity may provide clarity and/or insight as to whether the source of information is at least one of misleading, misguided, or false content. Additionally, the system for automated assessment of media content for sincerity may enable a user to evaluate whether the source of information is reliable and/or trustworthy. As a nonlimiting example, if the source of information has a consistently low grade and/or level of integrity, the user may choose to receive information from another source.

Aspects of the present disclosure may relate to systems and methods for automated assessment of media content for sincerity (hereinafter the “system”) 300.

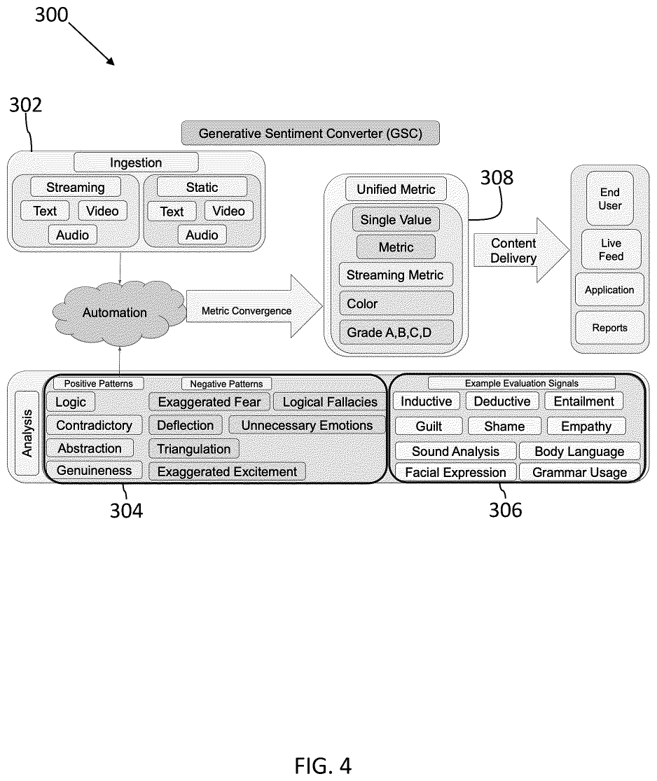

Referring to FIG. 3, the system 300 of the present disclosure may be designed to operate on a distributed computing architecture, which comprises the one or more client devices 102-106 and servers 107-109. Such an architecture may facilitate the ingestion, processing, and analysis of media content to produce a final score reflecting the sincerity and/or integrity of media content 302.

In an embodiment, the system 300 may efficiently handle large volumes of data from diverse sources. To illustrate, the one or more client devices 102-106 may serve as endpoints for data collection and user interaction and are equipped with network interfaces 214 to facilitate communication with servers 107-109 and other devices.

Servers 107-109 may provide the system 300 with centralized processing power and storage capabilities. Additionally, said servers 107-109 may host one or more machine learning algorithms and manage data processing tasks, thus ensuring scalability and reliability.

Moreover, said distributed computing architecture may support both wired and wireless communication protocols, including Bluetooth, LoRaWAN, Wi-Fi, Zigbee, and the one or more wireless networks 110. The communication protocols may enable seamless data exchange between the one or more client devices 102-106.

In an embodiment, the system 300 may ingest data from multiple sources, including text, audio, and video media. The data ingestion process may employ APIs and web scraping, providing structured access to data from online platforms, while web scraping extracts data from web pages. These methods may ensure comprehensive data collection. Furthermore, the system 300 may employ sensors that capture real-time data, such as audio and video feeds, while direct database connections allow access to structured datasets.

Once ingested, the data may undergo preprocessing, which includes data cleaning to remove noise, duplicates, and irrelevant information, ensuring data quality and consistency. Normalization may scale the ingested data to a common range or format using techniques, such as Min-Max Scaling or Z-Score Normalization, ensuring comparability and reducing biases. Additionally, the ingested data may undergo feature extraction, which employs the one or more machine learning algorithms to parse the ingested data to identify relevant attributes and characteristics, selecting features that are indicative of sincerity, such as emotional tone and logical structure.

Yet further, the ingested data may be transformed, wherein said data is converted into formats suitable for analysis, including numerical vectors for textual content, facilitating efficient processing by machine learning models.

As previously mentioned, the system 300 may employ the one or more machine learning algorithms, including large language models (LLMs) and natural language processors (NLPs), to analyze the preprocessed data. Such an analysis may involve sentiment detection via identifying emotional tones within the media content 302, such as positivity, negativity, or neutrality, providing insights into the sincerity of the content. The system 300 may employ advanced natural language processing techniques, including deep learning models like BERT or ROBERTa, to capture nuanced emotional expressions and contextual sentiment shifts within the media. These models may be fine-tuned on domain-specific datasets to improve accuracy in detecting subtle emotional cues, sarcasm, and implicit sentiment that may not be apparent through traditional lexicon-based approaches. Additionally, the system 300 may incorporate multimodal sentiment analysis for audio-visual content, analyzing vocal intonations, facial expressions, and body language in conjunction with textual data to provide a more comprehensive assessment of emotional tone and sincerity.

Logical structural evaluation may assess the coherence and validity of arguments presented in the media content 302, ensuring that the content follows a structured, rule-based framework. For instance, the system 300 may generate scores for various metrics, including genuineness, consistency, abstractness, logic, fallacy, exaggeration of irrational fear, exaggeration of excitement, unnecessary emotional content, consistency of reasoning across media sources, triangulation of an argument, deflection in conversation, etc. These scores may ultimately be compiled to produce a final score, which may subsequently be displayed to users on the one or more client devices 102-106.

In an embodiment, the scoring process may involve metric calculation based on predefined criteria, reflecting the sincerity and integrity of the content. Score compilation may aggregate scores to produce a comprehensive evaluation, which may include averages, medians, or modes.

In a further embodiment, the system 300 may integrate both software and hardware components to facilitate its operation. For example, the software component may include the one or more machine learning algorithms to perform data analysis and scoring.

Such a system 300 may be hosted on the servers 107-109 to be accessed via the one or more client devices 102-106. High-performance processors, memory, and storage devices may support data processing tasks. Network interfaces 214 may enable communication between the one or more client devices 102-106. In summary, the system 300 may provide a technologically advanced framework for assessing media content 302 for sincerity. By leveraging distributed computing architecture, machine learning algorithms, and robust data processing techniques, the system 300 offers accurate and efficient evaluations, contributing to the mitigation of misinformation in the digital landscape.

The system 300 may ingest media content 302 from one or more sources of information (the “media”) 302. In an embodiment, the media 302 may be comprised of at least one of textual media, video media, and audio media. For instance, the system 300 may include network interfaces 214, which facilitate at least one of wired and wireless communication protocols, including, but not limited to, Ethernet, Wi-Fi, Bluetooth, the one or more wireless networks 110, LoRaWAN, Zigbee, etc. Said network interfaces 214 may enable the system 300 to connect to various media sources, facilitating the ingestion of media 302 from online sources, including, streaming services, local devices, social media, etc.

Furthermore, the system 300 may employ APIs and/or web scraping techniques, such as, Python-based scraping tools (e.g., BeautifulSoup, Scrapy, Selenium, Requests, etc.); JavaScript-based scraping tools (e.g., Puppeteer, Cheerio, Playwright, etc.); or other tools like Octoparse, ParseHub, Import.io, etc. Said APIs and/or web scraping techniques may collect media 302 from the online sources.

For example, the system 300 may ingest a podcast, via the network interfaces 214 and APIs and/or web scraping techniques, wherein the system 300 is able to ingest the auditory input of said podcast. In another example, the system 300 may ingest static and/or dynamic media that is collected via the network interfaces 214 and APIs and/or web scraping techniques.

As a nonlimiting example, the system 300 may ingest static media, such as a printed publication (e.g., newspapers, magazines, journals, etc.). In such an example, a user may upload a PDF of the static media to the system 300. Subsequently, the system 300 may parse the PDF using programs such as, PyPDF2, pdfminer.six, PyMuPDF, PDFPlumber, Camelot/Tabula, Adobe Acrobat Pro, ABBYY FineReader, Foxit PhantomPDF, Nitro PDF, pdftotext, pdfgrep, etc.

Additionally, the system 300 may ingest dynamic media. For instance, via the network interfaces 214 and APIs and/or web scraping techniques, the system 300 may ingest dynamic media such as a blog article, wherein the article is ingested at a first date, and is subsequently ingested at a second date, if said article was changed between the first and the second date.

After the media 302 has been ingested by the system 300, the system 300 may preprocess it, such that the media 302 is suitable for analysis. To illustrate, preprocessing the media 302 ingested by the system 300 ensures that it is transformed into a format suitable for analysis.

As a nonlimiting example, a news article may be ingested from an online source by the system 300. In such an example, said article may be subsequently preprocessed by the system 300, wherein, in a first step, the article may undergo tokenization. During tokenization, the text comprising the article may be broken down into individual words or phrases using natural language processing tools including, NLTK and/or spaCy. In a second step, the article may undergo stop word removal, wherein commonly used words, such as “and,” “the,” and “is,” are removed from the article. In a third step, said article may undergo stemming and lemmatization, wherein the words comprising the article are reduced to their base or root form, enabling more consistent analysis. To illustrate, “running” may become “run.” In a fourth step, the article may subsequently be normalized, wherein the text comprising the article is converted to lowercase, thus ensuring uniformity and reducing potential variability during analysis.

As a further nonlimiting example, a podcast may be ingested from an online source, wherein the podcast may be preprocessed by the system 300. To illustrate, in a first step, background noise may be filtered out of the audio comprising the podcast. For instance, to improve transcription accuracy, audio processing software like Audacity or Adobe Audition may be employed to filter out the background noise. In a second step, the audio may subsequently be segmented. For example, the audio may be segmented into smaller segments necessarily facilitating improved processing efficiency of the system 300. In a third step, once the background noise has been removed and the audio has been segmented, the podcast may be transcribed into text using speech recognition tools like Google Speech-to-Text or IBM Watson Speech to Text. In such a step, the audio may be converted into text for subsequent analysis.

In another nonlimiting example, a video news report may be ingested from an online source by the system 300. Subsequent to being ingested, the video news report may be preprocessed by the system 300. In a first step, audio from the video news report may undergo processing using a method identical to that of the podcast described above. In a second step, video from the video news report may undergo frame analysis. To illustrate, during frame analysis, frames may be extracted from the video and analyzed using Optical Character Recognition (OCR) to capture any text displayed on-screen, using tools like Tesseract, ABBYY FineReader, etc. In a third step, the video may be segmented into scenes to identify distinct parts for focused analysis, using video processing software such as, OpenCV.

In yet a further nonlimiting example, a scanned news article may be ingested from an online source by the system 300. Said scanned news article may be preprocessed by the system 300, wherein during a first step, the scanned news article is enhanced. Specifically, the contrast and brightness of the scanned news article may be adjusted to improve text visibility and recognition accuracy. Further, in a second step, text from the scanned news article may be extracted from the enhanced image using OCR software. In such a step, printed text comprising the scanned news article may be converted into digital text for subsequent analysis by the system 300. In a third step, upon the text being extracted, the system 300 may review and correct any recognition errors, using tools like, Hunspell, spell-checking features in Python libraries (e.g., pyspellchecker), advanced language models (e.g., GPT-3, BERT, etc.), Grammarly, LanguageTool, etc.

Once the media 302 has been preprocessed, it may be analyzed by the system 300. In an embodiment, the system 300 may analyze the media 302 for one or more sentiments 304, wherein said sentiments 304 may comprise at least one of abstractness, consistency, genuineness, logic, fallacy, exaggeration of irrational fear, exaggeration of excitement, unnecessary emotional content, consistency of reasoning across media sources, triangulation of an argument, deflection in conversation, etc.

Using the tools described below, the sentiment abstractness may be analyzed to determine whether the media 302 is abstract or concrete. For example, the media 302 may not describe a topic in detail, thus the system 300 would deem said media 302 as more abstract, whereas media 302 utilizing more detail may be deemed less abstract by the system 300.

In an embodiment, the system 300 may assess abstractness by determining whether the media 302 utilizes abstract concepts, wherein a high score is generated, via the system 300, for more abstract concepts and a low score is generated for less abstract concepts. In such an embodiment, the system 300 may employ NLP tools (e.g., NLTK, spaCy, etc.) to perform semantic analysis on the media 302. For example, the system 300 may parse text comprising the media 302 and identify abstract concepts by analyzing the semantic relationships between words.

In an embodiment, the system 300 may utilize word embeddings to assess the abstractness of the media 302. Specifically, the system 300 may utilize Word2Vec, GloVe, BERT, and the like to represent words comprising the media 302 in a continuous vector space. That is, said word embeddings may capture semantic similarities and differences between words, allowing the system 300 to identify abstract concepts based on their proximity to known abstract terms in the vector space.

Moreover, the system 300 may employ one or more conceptual density algorithms to assess the abstractness of the media 302. For example, the one or more conceptual density algorithms may measure the conceptual density of the media 302. To illustrate, the one or more conceptual density algorithms may calculate the ratio of abstract terms to concrete terms within a given passage, wherein abstract terms are identified using a predefined lexicon or ontology of abstract concepts. Thus, the system 300 may further leverage lexical resources like WordNet, that provide a hierarchical structure of words and their meanings. Said lexical resource may distinguish between abstract and concrete terms, to aid in quantifying the level of abstractness in the media 302.

In yet a further embodiment, the system 300 may employ support vector machines (SVMs) and/or neural networks, for classifying the media 302 based on its level of abstractness. In such an embodiment, the system 300 may extract features from the media 302 indicative of abstractness, such as the frequency of abstract nouns, the use of metaphors or analogies, and the presence of hypothetical scenarios.

Ultimately, once the system 300 has assessed the media's abstractness, the system 300 may produce a score. For instance, the system 300 may assign an abstractness score to the media 302, wherein a high score is generated for media 302 that predominantly uses abstract concepts, whereas a low score may be assigned to media 302 that is more concrete and literal.

As mentioned above, the one or more sentiments 304 may comprise consistency. In one embodiment, the system 300 may assess consistency by ascertaining whether the media 302 treats a topic consistently throughout its duration. For example, the system 300 may analyze a video on a specific topic to determine whether said video treats the specific topic consistently throughout its duration.

To illustrate, the system 300 may employ topic modeling techniques, such as Latent Dirichlet Allocation (LDA), Non-negative Matrix Factorization (NMF), and the like to identify and track topics within the media 302. Said topic modeling techniques may allow the system 300 to ascertain whether a particular topic is treated consistently throughout the duration of the media 302.

In an embodiment, the system 300 may employ NLP tools (e.g., NLTK, spaCy, etc.) to perform semantic analysis on the media 302. To illustrate, the semantic analysis may ensure that the language and terminology related to a topic remain consistent throughout the duration of the media 302. As an example, the semantic analysis of the media 302 may involve analyzing word usage, synonyms, and/or context.

In a nonlimiting example, if the media 302 is comprised of video content, the system 300 may use temporal analysis to evaluate how a topic is addressed over time. Said temporal analysis may involve segmenting the video into scenes and analyzing each segment for consistency in topic treatment.

Similar to abstractness, once the system 300 has analyzed the media 302 for consistency, the system 300 may produce a score. For instance, the system 300 may assign a consistency score to the media 302, wherein the more consistent the treatment of a topic within the media 302 is, the higher the consistency score.

Moreover, the system 300 may assess genuineness to determine whether the media 302 addresses multiple sides of a specific issue. As a nonlimiting example, the System 300 may analyze a written article on a specific issue, wherein the system 300 assesses whether said article addresses opposing viewpoints regarding the specific issue.

In particular, the system 300 may use sentiment analysis tools (e.g., VADER, TextBlob, NLTK, SentiStrength, etc.) to evaluate the emotional tone of the media 302. To illustrate, evaluating the emotional tone of the media 302, via the sentiment analysis tools, may enable the system 300 to determine whether the media 302 addresses multiple sides of an issue genuinely.

Furthermore, the system 300 may employ contextual analysis to recognize contextual cues indicating the media's 302 genuineness. For instance, said contextual cues may include balanced argumentation, acknowledgment of opposing viewpoints, and the use of evidence to support claims. Moreover, the contextual cues may be further comprised of one or more characteristics 306, such as, a speaker's body language, facial expressions, and/or grammar. Thus, the system 300 may assess the speaker's genuineness based on the system's 300 analysis of said reporter's one or more characteristics 306.

As a nonlimiting example where the media 302 comprises video content, the system 300 may utilize multimodal analysis to assess genuineness based on visual and/or auditory cues. For instance, the system 300 may employ facial recognition and analysis tools (e.g., OpenCV, Dlib, etc.) to analyze a speaker's expressions; one or more object detection algorithms (e.g., YOLO, Faster R-CNN, etc.) to identify and track objects within video frames; and/or optical flow techniques (e.g., Lucas-Kanade Optical Flow, Horn-Schunck Optical Flow, Farneback Optical Flow, Flow Net, PWC-Net, Recurrent All-Pairs Field Transforms (RAFT), etc.) to estimate motion between consecutive video frames. Accordingly, the multimodal analysis may reveal subtle movements and gestures of a speaker in the media 302 indicative of sincerity or deception.

Additionally, the system 300 may assess logic within the media 302. For example, the system 300 may analyze a video to deduce whether said video utilizes at least one of inductive and deductive reasoning.

For example, the system 300 may extract features indicative of logical reasoning, such as keywords and phrases associated with logical connectors. In such an example, the system 300 analyzes the structure of arguments to identify logical sequences and inferential progressions, such as inductive reasoning, where specific observations lead to general conclusions, and deductive reasoning, where general principles lead to specific conclusions.

Further, the system 300 may be designed to evaluate media content 302 for both formal and informal fallacies, providing a comprehensive analysis of the logical integrity of the content 302. Formal fallacies, which arise from flawed logical structures, are identified by analyzing the argument's framework to detect errors such as affirming the consequent or denying the antecedent. Informal fallacies, on the other hand, are content-based and involve reasoning errors such as emotional manipulation, misrepresentation, or false assumptions.

For example, the system 300 may parse the text or transcribed audio comprising the media content 302 to map out the logical flow and identify structural inconsistencies. The system 300 may employ NLP techniques to detect these fallacies by analyzing the language used, identifying emotionally charged language, and cross-referencing claims with factual data to spot misrepresentations.

Moving on, the system 300 may assess exaggerated fear within the media content 302 using a multi-faceted approach that combines NLP and machine learning techniques to evaluate the emotional tone and reasoning behind fear-related claims.

For instance, the system 300 may begin by parsing text or transcribed audio comprising the media content 302 to identify language that conveys fear, using NLP tools to detect emotionally charged words and phrases suggestive of an alarmist tone. Subsequently, the system 300 may assess the context in which these expressions occur. For example, the system 300 may distinguish between justified concerns and disproportionate fear responses, which may involve analyzing the logical structure of the arguments within the media content 302 to determine whether the fear expressed is based on factual evidence or is being used manipulatively to distort perception.

As a nonlimiting example, machine learning models, trained on datasets containing examples of both rational and exaggerated fear, may be employed to classify the text based on the level of fear expressed. These models may recognize patterns indicative of fear-mongering, such as the amplification of threats without supporting evidence.

Moreover, the system 300 may assess exaggerated excitement within the media content 302. Specifically, the system 300 may parse text or transcribed audio comprising the media content 302 to identify language that conveys excitement, using NLP tools to detect words and phrases that suggest heightened enthusiasm.

For instance, the context in which these expressions occur may be evaluated to determine whether the excitement is proportionate to the subject matter or if it represents an overstatement that may distort reality. Such an evaluation may involve analyzing the logical structure of the arguments within the media 302 to assess whether the enthusiasm is supported by factual evidence or is being used to manipulate emotional engagement. Machine learning models may be trained on datasets containing examples of both genuine and exaggerated excitement and subsequently employed by the system 300 to classify the media content 302 based on the level of excitement expressed. These models may recognize patterns indicative of overstated enthusiasm, such as the use of hyperbolic language or the amplification of significance without supporting evidence.

As mentioned above, the system 300 may assess unnecessary emotional expressions within a speaker's discourse. The system 300 may evaluate the context in which these emotions are expressed and subsequently determine whether they contribute meaningfully to the argument or if they appear excessive, misplaced, or disruptive. Such an evaluation may involve analyzing the logical structure of the discourse to assess whether emotional expressions align with the topic or serve as distractions.

Additionally, the system 300 may cross-reference emotional expressions with psychological concepts, such as projection, slips, and reaction formation, to reveal a psychological footprint that can be used to understand the inner workings of the speaker's psyche. This analysis highlights deep-seated biases, insecurities, or defense mechanisms that influence communication, offering a nuanced understanding of the speaker's intent and the potential impact on the audience.

By detecting excessive, misplaced, or irrelevant emotional expressions, the system 300 may identify instances of emotional manipulation or cognitive bias, signaling poor emotional regulation or deliberate distraction. Continuous learning and adaptation by the machine learning algorithms ensure that the system 300 remains effective in identifying and evaluating unnecessary emotional expressions in various contexts, contributing to a comprehensive assessment of the speaker's communication and emotional intelligence.

Yet further, the consistency rate across media sources of the media content 302 may be ascertained by the system 300. Such an assessment may involve a detailed comparison of reasoning patterns between multiple bodies of text or transcribed audio comprising the media content 302 to assess coherence and alignment in argumentation.

As a nonlimiting example, topic modeling techniques like LDA or NMF, may be employed to identify and track topics within the media content 302. Said models may aid in ascertaining whether a particular topic within the media content 302 is treated consistently across different media sources. The system 300 may perform a step-by-step examination of the media content 302, using algorithms to detect areas of agreement and inconsistency in reasoning, which may involve comparing the logical flow and coherence of arguments, identifying contradictions or shifts in narrative.

In an embodiment, the system 300 may assess the media content 302 for triangulation of an argument. To illustrate, the system 300 may parse the text and/or transcribed audio comprising the media content 302 to extract features indicative of triangulation, such as references to third-party opinions, authority figures, or comparative arguments. NLP tools may subsequently be employed to detect language patterns that suggest the use of external validation or indirect reasoning, such as phrases that invoke social consensus or appeal to authority.

Moreover, the system 300 may recognize patterns that indicate manipulation, such as the frequent use of external quotes or comparisons without supporting evidence by evaluating the logical structure of the argument, assessing whether it is self-reliant and logically sound or if it attempts to control perception by introducing outside influences. As a nonlimiting example, contextual analysis further refines the assessment by examining the context in which external references are made, determining whether they are used to support or distort the argument.

By identifying triangulation, the system 300 may highlight instances where the speaker in the media content 302 may be distorting reality, manufacturing authority, or pressuring agreement through indirect argumentation.

In another embodiment, the system 300 may assess the media content 302 to determine whether a speaker was deflecting in a conversation or interview. To illustrate, NLP tools may be employed to parse the text or transcribed audio of the media content 302, to identify linguistic patterns indicative of deflection, such as vague responses, topic shifts, or evasive language. For instance, the system 300 may recognize patterns indicative of deflection, such as the use of filler words, rhetorical questions, or abrupt changes in subject matter, wherein the logical flow and coherence of the dialogue may be evaluated by the system 300, assessing whether the speaker provides clear, relevant responses or instead shifts focus in a way that obstructs meaningful dialogue.

Assessing the context and structure of the conversation comprising the media content may enable the system 300 to further refine its assessment of deflection by examining the context and structure of the conversation, identifying areas where the speaker may be deliberately avoiding critical issues or redirecting discussions.

By analyzing deflection alongside other negative traits, such as fallacies, exaggeration, and inconsistency, the system 300 gains a comprehensive understanding of the speaker's psychological, cognitive, and ethical dimensions. A high level of deflection suggests manipulative, evasive, or intellectually dishonest behavior, offering a nuanced assessment of the speaker's intent and the potential impact on the audience. Continuous learning and adaptation ensure that the system 300 remains effective in detecting and evaluating deflection in various contexts, contributing to a thorough evaluation of the speaker's communication integrity.

Further, the system 300 may employ a context matrix to analyze the one or more characteristics 306. Moreover, the system 300 may analyze the logic of the media 302. In a further embodiment, the LLM and/or NLP may perform the analyzation of the media 302. Additionally, as the LLM and/or NLP analyzes more media 302, said LLM and/or NLP may become more adept at measuring human integrity.

Additionally, the system 300 may utilize an Artificial Intelligence (AI) engine. In an embodiment, the media 302 ingested by the system 300 may be utilized as training data for the AI engine. In another embodiment, methods of human intelligence may be utilized as the training data for the AI engine. For example, human reasoning skills such as, inductive reasoning and deductive reasoning, may be employed as training data for the AI engine.

In a further embodiment, the AI engine may be comprised of at least one of a large language model (LLM) and a natural language processor (NLP). As a nonlimiting example, the media 302 ingested by the system 300 may be utilized to train the LLM and/or NLP, such that said LLM and/or NLP is able to analyze the media 302 and produce a final score 308 based on one or more sentiments 304 and 306 of said media 302. Further, one or more AI engines may be employed. In an additional embodiment, the one or more AI engines may be employed to generate higher levels of accuracy regarding the assessment of human integrity. As a further nonlimiting example, the system 300 may employ multiple LLM's, so that the system 300 is better able to assess whether a human is telling the truth.

Upon analyzation of the one or more sentiments 304, the system 300 may assign a score to each of the one or more sentiments 304. In an embodiment, the score for each of the one or more sentiments 304 may be on a scale of 1 to 10. For example, abstractness may have a score 6, consistency may have a score of 8, etc.

In another embodiment, the score may be any number between 1 and 100. However, any range of numbers may be utilized to assign the score to the one or more sentiments 304. For example, the system 300, after analyzing the one or more characteristics 306 of a news reporter, may assign a score for said reporter's genuineness, wherein the score is 10 for very genuine or 1 for lacking any semblance of genuineness.

Moreover, the system 300 may assign the score for the logic of the media 302. In a nonlimiting example, the system 300 may assign a score of 10 for a well-reasoned articulation of facts encompassing a news event, while the system 300 may assign a score of 1 for a poorly thought out and under researched reporting on the same news event.

In a further embodiment, the system 300 may additionally assign a score for one or more categories, including but not limited to said reporter's truthfulness in the face of crisis, the reporter proffering publicly unpopular truths, whether said reporter echoes the opinions of corporate leaders or politicians, whether the reporter attempts to sell a fantasy, and whether the reporter attempts to sell a fantasy in the face of crisis. In an alternative embodiment, the LLM and/or NLP may produce the score for the one or more sentiments 304 in real time. For example, as dynamic media (e.g., a live news broadcast) is occurring, the LLM and/or NLP may produce a score for the one or more sentiments 304 contemporaneously with the dynamic media.

The system 300, after assigning the score to each of the one or more sentiments 304, may compile said scores and produce a final score 308. In an embodiment, the final score 308 may reflect the score of each of the one or more sentiments 304. In such an embodiment, the final score 308 may be a weighted average of the scores for abstractness, consistency, genuineness, and logic. The system 300 may allow for customizable weighting of each sub-score, enabling users to prioritize certain aspects based on the specific context or requirements of their analysis. For instance, in evaluating scientific literature, the weight assigned to consistency and logic may be higher than that of abstractness. Conversely, when analyzing creative writing, abstractness might carry more weight. This flexible approach ensures that the final score reflects the most relevant aspects of the content being evaluated.

Furthermore, a score of 1-3 may be labeled as “Low Integrity,” 3-6 as “Moderate Integrity,” 6-8 as “High Integrity,” and 8-10 as “Exceptional Integrity.” These labels may be displayed alongside the numerical score in the graphical user interface (e.g., in real time on a display overlaying the delivered content), providing users with an immediate, intuitive understanding of the content's assessed integrity level.

For example, abstractness may have a score of 7, consistency may have a score of 6, genuineness may have a score of 8, and logic may have a score of 7, the system 300 may compile the aforementioned scores and produce a final score of 7 (i.e., the average of the scores for abstractness, consistency, genuineness, and logic). In an alternative embodiment, the final score 308 may include the median and/or the mode of the compiled scores. Further, the final score may be the highest or the lowest of the compiled scores.

Furthermore, the system 300 may generate the final score 308 contemporaneously with the media 302. In an embodiment, the system 300 may: (1) analyze the media 302 as it occurs; (2) generate a score for the one or more sentiments 304; and (3) compile each score to create the final score 308, wherein said final score 308 may be displayed upon a display of the client devices 102-106. For example, as a reporter discusses a first event, the system 300 may contemporaneously produce an abstractness score of 7, a consistency score of 6, a genuineness score of 8, and a logic score of 7, thus resulting in a final score of 7, wherein the final score of 7 may be contemporaneously displayed on the display of the client devices 102-106. Furthermore, the system 300 may display, via the display, the final score 308 as it changes in real time. For example, the system 300 may be a web browser extension that works in the background of the client devices 102-106. Additionally, the system 300 may be a web based and/or mobile application a user may access with the client devices 102-106. Such web based and/or mobile applications may be comprised of a headless API. In another example, when the news reporter begins to discuss a second event, the system 300 may produce an abstractness score of 4, a consistency score of 3, a genuineness score of 5, and a logic score of 4, thus resulting in a final score of 4, wherein the change in final score from 7 to 4 may be displayed, via the display, in real time. In an additional embodiment, the LLM and/or NLP may produce the final score 308 for the media 302 in real time. For example, as dynamic media (e.g., a live news broadcast) is occurring, the LLM and/or NLP may compile the scores for each of the one or more sentiments 304 and generate the final score 308 contemporaneously with the dynamic media.

For instance, the system's 300 ability to generate and display the final score 308 contemporaneously with the media 302 elicits a significant technical improvement in real-time content analysis and user feedback. By leveraging advanced natural language processing techniques and efficient scoring algorithms, the system 300 overcomes the challenge of processing and evaluating complex media content on-the-fly. This real-time capability enables users to receive immediate, dynamic assessments of media integrity as the content unfolds, rather than waiting for post-hoc analysis. The implementation as a web browser extension or mobile application with a headless API further enhances accessibility and integration, allowing seamless background operation without disrupting the user's primary content consumption experience. Moreover, the system's 300 capacity to rapidly adjust scores in response to changing topics or events within the media demonstrates a sophisticated adaptability to context shifts. This real-time, adaptive scoring mechanism represents a substantial advancement over traditional static analysis methods, providing users with a continuously updated, nuanced understanding of media integrity that can inform their interpretation and decision-making processes as they engage with dynamic content.

In an embodiment, the system 300 may integrate sentiment analysis with logical structural analysis to provide a more comprehensive assessment of media content integrity. Such integration may allow for a nuanced evaluation that goes beyond traditional sentiment analysis in the existing art.

The system 300 may include a logic-structure evaluation module that identifies premises, conclusions, and inferential transitions within the media content 302. Such a module may employ advanced natural language processing techniques to parse the structure of arguments and detect logical frameworks within the text. For example, the module may identify key statements that serve as premises, recognize concluding remarks, and track the progression of ideas that form inferential chains.

In addition to sentiment analysis, the system 300 may compute a logical coherence score based on the structural consistency of the arguments presented in the media content 302. This score may reflect how well the content aligns with formal logic schemas. For instance, the system 300 may evaluate whether conclusions logically follow from the stated premises, whether there are gaps in the reasoning, or if the argument structure adheres to recognized patterns of valid inference.

The logical coherence score may be particularly valuable when analyzing structured texts such as patent claims, legal arguments, or persuasive content. In these contexts, the ability to quantify the mathematical-like logical cohesion in language provides a unique insight into the integrity of the content.

The system 300 may then integrate this logic score with the sentiment profiles generated through sentiment analysis to form a combined “integrity” score. This integration may involve weighted algorithms that balance the importance of logical structure against emotional content, providing a more robust and nuanced assessment of the media's overall integrity.

To enhance user understanding and interaction with the analysis, the system 300 may generate optional visualizations. Said visualizations may include logic graphs that visually represent the structure of arguments within the content, showing how different premises connect to conclusions and highlighting the strength of these connections. Additionally, the system 300 may provide breakdowns of emotional and logical content, allowing users to see at a glance the balance between sentiment and reasoning within the analyzed media.

The integration of logical structural analysis with sentiment analysis allows the system 300 to provide a more comprehensive evaluation of media content 302. By examining both the emotional tone and the logical framework of the content 302, the system 300 can offer insights that may be particularly valuable in fields where both persuasive language and logical rigor are important, such as law, academia, journalism, and business communications.

In an embodiment, the logic-structure evaluation module may employ machine learning algorithms trained on datasets of well-structured arguments to improve its ability to recognize and evaluate logical structures. These algorithms may be continuously updated to refine their accuracy in identifying complex reasoning patterns across various types of media content 302.

The system 300 may also allow for customization of the weighting between logical coherence and sentiment in calculating the final integrity score. This flexibility enables users to adjust the system's 300 focus based on the specific requirements of their analysis, whether they prioritize emotional impact, logical soundness, or a balanced consideration of both.

In a further embodiment, the logic-structure evaluation module may employ a combination of rule-based systems and machine learning models to analyze the logical structure of the media content. The rule-based systems may include predefined heuristics for identifying logical connectives, argument indicators, and common reasoning patterns. The machine learning models may encompass a variety of techniques to capture different aspects of logical structure.

For instance, the module may utilize discourse marker analysis to identify logical relationships between sentences based on connective words and phrases. Syntactic parsing techniques, such as dependency parsing, may be employed to analyze the grammatical structure of sentences, helping to identify subject-predicate relationships that often indicate premises or conclusions.

The module may also incorporate semantic role labeling to determine the roles that different phrases play within a sentence, which can be crucial for distinguishing between factual statements and inferential claims. Coreference resolution techniques may be used to track the progression of ideas across sentences by identifying when different mentions refer to the same entity.

Advanced argument mining techniques may be implemented to identify argumentative structures within the text. These may be based on models like ArgumenText or IBM's Debater, which can be fine-tuned on domain-specific datasets to improve accuracy. Sequence labeling models, such as Conditional Random Fields (CRFs) or Bidirectional Long Short-Term Memory (BiLSTM) networks, may be employed to tag sentences or clauses as premises, conclusions, or transitions.

The logic-structure evaluation module may also leverage transformer-based models like BERT or GPT, fine-tuned on tasks related to argument structure identification. These models can generate embeddings that capture the logical relationships between different parts of the text.

To represent the logical structure of arguments, the module may construct a graph representation. In this graph, nodes represent individual statements or claims, while edges represent the logical relationships between these statements. This graph-based approach allows for the application of graph algorithms, such as PageRank or community detection, to identify key premises and conclusions within the argument structure.

The system 300 may allow for customization of the weighting between the logical coherence score and the sentiment score when calculating the combined integrity score. This feature enables users to adjust the system's 300 focus based on the specific requirements of their analysis. For example, users analyzing legal documents may choose to assign a higher weight to the logical coherence score, while those analyzing social media content might prioritize the sentiment score.

To continuously improve the accuracy of the logic-structure evaluation module, the system 300 may implement an active learning process. This process incorporates feedback from human experts to refine the module's performance over time. For instance, the system 300 may present its analysis results to human experts, who can then correct or validate the identified logical structures. These corrections are fed back into the system 300, allowing it to learn from expert input and improve its accuracy on future analyses.

The active learning process may employ techniques such as uncertainty sampling, where the system 300 identifies and presents the most uncertain cases to human experts for review. This approach helps to efficiently allocate human expertise to the cases where it is most needed, maximizing the impact of expert feedback on the system's 300 overall performance.

In an embodiment, the logic-structure evaluation module may use a predefined lexicon of discourse markers (e.g., “therefore,” “because,” “consequently”) to identify logical relationships between sentences. Natural Language Toolkit (NLTK) or spaCy libraries may be used to tokenize the text and match tokens against this lexicon.

Additionally, the module may leverage dependency parsing techniques, such as those provided by the Stanford Parser or spaCy's dependency parser, to analyze the grammatical structure of sentences, which may help identify subject-predicate relationships and subordinate clauses that often indicate premises or conclusions.

Moreover, the logic-structure evaluation module may employ semantic role labeling algorithms, such as those based on PropBank or FrameNet, to identify the roles that different phrases play within a sentence (e.g., agent, patient, instrument). As a nonlimiting example, such semantic role labeling algorithms may facilitate distinguishing between statements of fact and inferential claims.

To track the progression of ideas across sentences, the logic-structure evaluation module may use coreference resolution techniques. Libraries such as NeuralCoref or AllenNLP's coreference resolution model may be employed to identify when different mentions refer to the same entity across the text.

Further, the module may incorporate argument mining techniques (e.g., ArgumenText or IBM's Debater), to identify argumentative structures within the text. Said techniques may be fine-tuned on domain-specific datasets to improve accuracy.

Yet further still, the module may employ sequence labeling models, such as Conditional Random Fields (CRFs) or Bidirectional Long Short-Term Memory (BiLSTM) networks, trained on annotated corpora of argumentative texts, to tag sentences or clauses as premises, conclusions, or transitions.

In another embodiment, the module may utilize pre-trained language models like BERT, GPT, or variants thereof, that are fine-tuned on tasks related to argument structure identification. Said language models may be used to generate embeddings that capture the logical relationships between different parts of the text.

In yet a further embodiment, the logic-structure evaluation module may construct a graph representation of the argument structure, where nodes represent statements and edges represent logical relationships. Graph algorithms, such as PageRank or community detection, may be applied to this representation to identify key premises and conclusions.

The logic-structure evaluation module may combine the outputs of these various techniques using an ensemble approach, potentially employing a voting mechanism or a meta-classifier to make final decisions about the logical structure of the text. The module may also incorporate a feedback loop, allowing human experts to correct and refine its analyses, thereby improving its performance over time through active learning techniques.

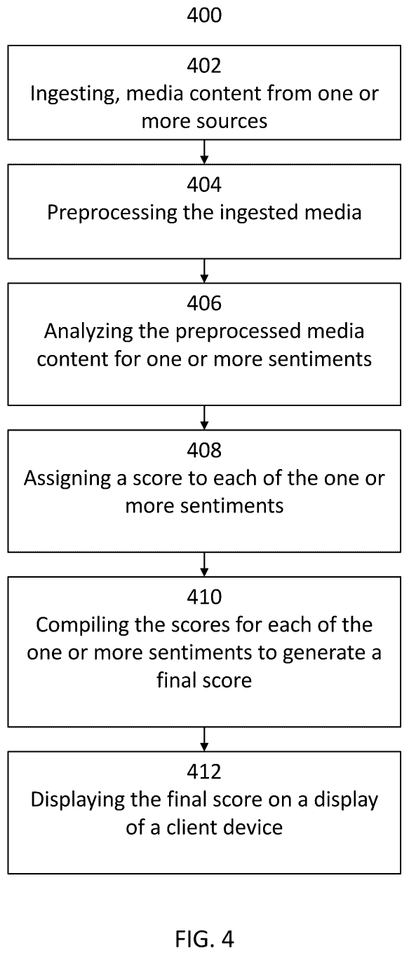

Turning to FIG. 4, a method for automated assessment of media content for sincerity (the “method”) 400 may be employed to assess the integrity of information. In a first step 402 of the method 400, media content, from one or more sources, may be ingested.

In an embodiment, the media may be comprised of dynamic or static media. For example, dynamic media may encompass live video, live streaming, internet blogs, etc. Whereas static media may encompass printed publications, pre-recorded audio and/or video, etc. In another embodiment, the media may come from a plurality of media outlets.

In one embodiment, the media content may be comprised of real-time data streams, wherein said media content may be continuously ingested as it is broadcasted. Such real-time ingestion may be achieved via the network interfaces 214, supporting high-speed data transfer, which necessarily ensures minimal latency in data acquisition.

In another embodiment, the media content may be comprised of at least one of textual media, video media, and audio media. For instance, the network interfaces 214, facilitating wired and/or wireless communication protocols (e.g., Ethernet, Wi-Fi, Bluetooth, the one or more wireless networks 110, LoRaWAN, Zigbee, etc.), may connect to various media sources, facilitating the ingestion of media content from online sources, including, streaming services, local devices, social media, etc.

As a nonlimiting example, the media may come from legacy media companies (e.g., Fox, NBC, etc.), new media outlets (e.g., blogs, wikis, etc.), and/or social media (e.g., X formerly known as twitter, Facebook, etc.). Moreover, the method 400 may employ an AI engine, wherein said engine ingests the media. In an embodiment, the AI engine may be an LLM and/or NLP.

Furthermore, during said first step 402, an API and/or web scraping technique, such as, Python-based scraping tools (e.g., BeautifulSoup, Scrapy, Selenium, Requests, etc.); JavaScript-based scraping tools (e.g., Puppeteer, Cheerio, Playwright, etc.), or other tools like Octoparse, ParseHub, Import.io, etc. may be employed to collect media content from the online sources.

For example, the media content may include a podcast, wherein during the first step 402, auditory input from said podcast is ingested via the network interfaces 214 and APIs and/or web scraping techniques.

In another example, the method 400 may ingest static and/or dynamic media that is collected via the network interfaces 214 and APIs and/or web scraping techniques during the first step 402. As a nonlimiting example, the static media, may include printed publications (e.g., newspapers, magazines, journals, etc.). In such an example, a user may upload a PDF of the static media during the first step 402.

Additionally, the method 400 may ingest dynamic media at the first step 402. For instance, dynamic media such as a blog article may be ingested at various points in time via the network interfaces 214 and APIs and/or web scraping techniques.

Upon ingesting the media content during the first step 402, the method 400 may advance to a second step 404. During the second step 404, the media content may be preprocessed, such that said content is suitable for subsequent analysis (described in more detail below). To illustrate, preprocessing the ingested media content ensures that it is transformed into a format suitable for analysis.

As a nonlimiting example, a news article may be ingested from an online source. In such an example, said article may be subsequently preprocessed during the second step 404, wherein the article may undergo tokenization. During tokenization, the text comprising the article may be broken down into individual words or phrases using NLP tools including, NLTK and/or spaCy. Further, the article may undergo stop word removal, wherein commonly used words, such as “and,” “the,” and “is,” are removed from the article. Moreover, said article may undergo stemming and lemmatization, wherein the words comprising the article are reduced to their base or root form, enabling more consistent analysis. To illustrate, “running” may become “run.” Lastly, the article may subsequently be normalized, wherein the text comprising the article is converted to lowercase, thus ensuring uniformity and reducing potential variability during analysis.

As a further nonlimiting example, a podcast may be ingested from an online source during the first step 402 and subsequently preprocessed during the second step 404. To illustrate, background noise may be filtered out of the audio comprising the podcast. For instance, to improve transcription accuracy, audio processing software like Audacity or Adobe Audition may be employed to filter out the background noise.

Additionally, the audio may subsequently be segmented. For example, the audio may be segmented into smaller segments necessarily facilitating improved processing efficiency when subsequently analyzing the preprocessed media content. Segmenting the audio into smaller segments improves processing efficiency by allowing parallel processing of these segments, reducing the computational load on any single processing unit. This approach also may enhance accuracy by focusing on manageable portions of audio, making it easier to apply speech recognition and analysis tools effectively.

Further, once the background noise has been removed and the audio has been segmented, the podcast may be transcribed into text using speech recognition tools like Google Speech-to-Text or IBM Watson Speech to Text, wherein the audio may be converted into text for subsequent analysis.

In another nonlimiting example, a video news report may be ingested from an online source during the first step 402. Subsequent to being ingested, the video news report may be preprocessed during the second step 404, wherein audio from the video news report may undergo processing using tools identical to those described above for preprocessing auditory input.

Video from the video news report may undergo frame analysis, wherein frames may be extracted from the video and analyzed using OCR (to capture any text displayed on-screen), Tesseract, ABBYY FineReader, etc. Lastly, the video may be segmented into scenes to identify distinct parts for focused analysis, using video processing software such as, OpenCV.

Such segmentation may necessarily facilitate improved processing efficiency when subsequently analyzing the preprocessed media content. For example, extracting specific frames for OCR and segmenting videos into scenes enhances processing efficiency by focusing on relevant data, reducing computational overhead, and enabling parallel processing. Such a targeted approach ensures accurate text recognition and context-specific analysis, streamlining the workflow and improving the speed and quality of video content analysis.

In yet a further nonlimiting example, a scanned news article may be ingested from an online source at the first step 402. Said scanned news article may be preprocessed during the second step 404, wherein the scanned news article is enhanced. Specifically, the contrast and brightness of the scanned news article may be adjusted to improve text visibility and recognition accuracy.

Moreover, text from the scanned news article may be extracted from the enhanced image using OCR software, programs such as, PyPDF2, pdfminer.six, PyMuPDF, PDFPlumber, Camelot/Tabula, Adobe Acrobat Pro, ABBYY FineReader, Foxit PhantomPDF, Nitro PDF, pdftotext, pdfgrep, etc. Thus, printed text comprising the scanned news article may be converted into digital text for subsequent analysis.

Yet further, upon the text being extracted, the text may be reviewed and corrected for any recognition errors, using tools like, Hunspell, spell-checking features in Python libraries (e.g., pyspellchecker), advanced language models (e.g., GPT-3, BERT, etc.), Grammarly, LanguageTool, etc.

Once the media content has been preprocessed, it may subsequently be analyzed during a third step 406 of the method 400.

In an embodiment, during the third step 406, the preprocessed media content may be analyzed for one or more sentiments. For instance, the preprocessed media may be extracted for features indicative of one or more sentiments.

As a nonlimiting example, the one or more sentiments may fall into one of two groups-positive traits and negative traits. To illustrate, the positive traits may include abstractness, consistency, genuineness, logic, which may which indicate clarity, depth, and integrity of the preprocessed media content. Whereas, the negative traits may include fallacy analysis, exaggeration of fear, exaggeration of excitement, unnecessary emotional content, consistency across media, triangulation of an argument, and/or deflection in a conversation.

In an embodiment, the one or more sentiments may be analyzed using NLP tools (e.g., NLTK, spaCy, etc.). For example, abstractness may be analyzed by parsing text comprising the preprocessed media content and identifying abstract concepts via an analysis of the semantic relationships between words. To illustrate, word embeddings may be employed to assess the abstractness of the preprocessed media during the third step 406. Specifically, Word2Vec, GloVe, BERT, etc. may be utilized to represent words comprising the preprocessed media in a continuous vector space. That is, said word embeddings may capture semantic similarities and differences between words, allowing abstract concepts based on their proximity to known abstract terms in the vector space to be identified.

Said word embeddings may improve the ability to identify abstract concepts by analyzing the proximity of words to known abstract terms within the vector space. As a result, more accurate and context-aware analyses may be performed, which necessarily leads to better decision-making and insights, sentiment analysis, and content categorization.

In another embodiment, the NLP tools may perform semantic analysis on the preprocessed media. For instance, the semantic analysis may ensure that the language and terminology related to a topic within the preprocessed media remains consistent throughout the duration of said media. As a nonlimiting example, the semantic analysis of the preprocessed media may involve analyzing word usage, synonyms, and/or context.

Moreover, one or more conceptual density algorithms may be employed to analyze the one or more sentiments during the third step 406. As a nonlimiting example, the one or more conceptual density algorithms may measure the conceptual density of the preprocessed media.

To illustrate, the one or more conceptual density algorithms may calculate the ratio of abstract terms to concrete terms within a given passage, wherein abstract terms are identified using a predefined lexicon or ontology of abstract concepts. Lexical resources like WordNet, that provide a hierarchical structure of words and their meanings may additionally be utilized, wherein said lexical resources may distinguish between abstract and concrete terms, to aid in quantifying the level of abstractness in the preprocessed media.

In yet a further embodiment, SVMs and/or neural networks, may be employed for analysis of the preprocessed media content during the third step 406. For example, said SVMs and/or neural networks may classify the preprocessed media based on its level of abstractness. In such an embodiment, features indicative of abstractness, such as the frequency of abstract nouns, the use of metaphors or analogies, and the presence of hypothetical scenarios may be extracted from the preprocessed media content.

Additionally, one or more topic modeling techniques may be employed during the third step 406. As a nonlimiting example, the one or more topic modeling techniques may include LDA, NMF, etc. to identify and track topics within the preprocessed media. Said topic modeling techniques may ascertain whether a particular topic within the preprocessed media is treated consistently throughout the duration of said media.

In a nonlimiting examples, where the preprocessed media was formerly comprised of video content, a temporal analysis may be utilized to evaluate how a topic is addressed over time. Said temporal analysis may analyze each segment of the preprocessed video content for consistency in topic treatment.

Furthermore, sentiment analysis tools (e.g., VADER, TextBlob, NLTK, SentiStrength, etc.) may be employed to evaluate the emotional tone of the preprocessed media in the third step 406. To illustrate, evaluating the emotional tone of the preprocessed media, via the sentiment analysis tools, may determine whether said media addresses multiple sides of an issue genuinely.

In an embodiment, during the third step 406 of the method 400, contextual cues from the preprocessed media such as, a speaker's body language, facial expressions, and/or grammar may be analyzed.

For instance, tools including, OpenCV, Dlib, Microsoft Azure Face API, Google MediaPipe, Kinect SDK, and NVIDIA DeepStream SDK may be leveraged to analyze a speaker's body language, facial expressions, and/or grammar by leveraging computer vision and machine learning techniques to interpret visual cues from video content.

For example, OpenCV and Dlib may be used to detect and track facial landmarks, allowing for the analysis of facial expressions that convey emotions and intentions. As a further example, Microsoft Azure Face API provides cloud-based facial recognition and emotion detection, offering insights into the speaker's emotional state through facial analysis. Yet further, Google MediaPipe enables real-time tracking of facial and hand movements, facilitating the assessment of gestures and postures that contribute to body language interpretation.

As another example, Kinect SDK, designed for use with Kinect sensors, can track full-body movements, capturing gestures and postures that indicate confidence, openness, or defensiveness. Additionally, NVIDIA DeepStream SDK allows for the development of AI-powered video analytics applications, which can detect and interpret human poses and movements to analyze body language in dynamic environments. By integrating these tools, a comprehensive analysis of the speaker's body language, facial expressions, etc. may be performed. Which in turn, may provide valuable contextual information that enhances understanding of the speaker's communication and intent.

In a fourth step 408, upon the preprocessed media having been analyzed, a score for each of the one or more sentiments may be assigned, thus generating one or more scored metrics. In an embodiment, the score may be on a scale of 1 to 10. Such a scale may include decimal points up to a tenth of a whole number. For example, a score of 6.6. may be assigned to abstractness. However, any scale and any number may be suitable to comprise the assigned score. In an additional embodiment, the one or more analyzed metrics may be assigned a score by the AI engine.

In an embodiment, the score for each of the one or more sentiments may be generated using one or more scoring algorithms. To illustrate, linear regression models may be employed using programming languages and libraries such as Python (e.g., Scikit-Learn, Statsmodels, TensorFlow & Keras, PyTorch, etc.).

Moreover, decision trees may be used to assign scores to each of the one or more sentiments by creating a tree-like model of decisions based on feature values, wherein each path through the tree may lead to a score. Further, random forest algorithms may be employed to assign a score to each of the one or more sentiments.

The method 400 may be further comprised of a fifth step 410. In such a fifth step 410, the scores for each of the one or more sentiments may be compiled to produce a final score.

To illustrate, the scores for each of the one or more sentiments may first be normalized to ensure each of the scores are on the same scale. For instance, the score for each of the one or more sentiments may be measured on a scale of 1-10.

As a nonlimiting example, statistical and/or machine learning algorithms implemented using programming languages and libraries such as Python (e.g., pandas, NumPy, SciPy, SQLAlchemy), R (e.g., dplyr, ggplot2, tidyr), and MATLAB may be utilized to normalize the scores.

Upon normalization, the individual scores for each of the one or more sentiments may be compiled, and a final score may be produced. For instance, Database Management Systems (DBMS) such as SQL-based Databases may be utilized to compile the individual scores and produce the final score. As a nonlimiting example, the final score may be the average of the normalized scores for each of the one or more sentiments.

The method 400 may be further comprised of a sixth step 412, wherein the final score is displayed to a user. In an embodiment, the user may be able to view the final score on the one or more client devices 102-106. In such a step 412, the final score may be contemporaneously displayed as the final score is being generated. Contemporaneous display of the final score may be desirable for dynamic media. As a nonlimiting example, the final score may change as a news reporter changes topics, thus reflecting the integrity of said reporter based upon which topic is being reported.

In an embodiment, the system 300 may be configured for at least one of a client application and/or server to server communication. For example, the system 300 may be accessed via a website and/or application, wherein the website and/or application are able to display at least one of the one or more metrics and the final score. In such an example, the user may upload media to the website and/or application, wherein said website and/or application then display at least one of the one or more metrics and the final score to the user.

In an alternative example, the system 300 may only convey at least one of the one or more metrics and the final score from a first server to a second server. In such an example, the system 300 may utilize the API to ensure trust-based communication of the one or metrics and/or the final score between the first and second servers. However, one having ordinary skill in the art will recognize the system 300 may employ any suitable number of servers to convey the one or more metrics and/or the final score. As a nonlimiting example, the system 300 may function as an API, such that the system 300 enables communication between two or more computer programs. In such a nonlimiting example, the system 300 may run in the background of the client devices 102-106. Meaning, if the user is viewing media, the system 300 may automatically generate and/or display the one or more metrics and/or the final score.

As a nonlimiting example, the system 300 may analyze an individual and/or the individual's statements. In an embodiment, the individual may be a business leader (e.g., a corporate executive, a board member, etc.). In such an example, the system 300 may analyze the individual for the one or more metrics. For example, a business leader may host an earnings call with a company's board members, wherein the system 300 analyzes the business leader for the one or more metrics during said call. Further, as the call is in session, the system 300 may contemporaneously produce the final score as the business leader speaks, such that other individuals on the call may discern whether said business leader is telling the truth or lying.

In another example, the system 300 may utilize previous earnings call transcripts as training data. However, the system 300 may employ an algorithm or machine learning model trained on any suitable training data, whether that training data is hyper-specific to a given scenario (e.g., earnings calls) or more general (e.g., a collection of call transcripts). The system 300 may analyze snippets of conversation from said calls to better assess whether the individual is telling the truth or lying. Further, the system 300 may ingest the media 302 as training data. For example, the system 300 may analyze a plurality of earnings calls hosted by a business leader, such that the system 300 creates a truth profile for said business leader. In such an example, the system 300 may become adept at analyzing the one or more metrics of the business leader, and in turn, produce a more accurate final score.

Moreover, the system 300 may be configured to delineate a primary source from a secondary source. For example, the primary source may be the business leader, and the secondary source may be a spokesperson for the business leader. In an embodiment, the system 300 may better analyze the primary source based on the one or more metrics to produce the final score. The system 300 may be configured to better analyze the one or more metrics coming from the primary source because said primary source provides a first-hand account of information. Whereas the secondary source may merely parrot the information coming from the primary source. Thus, the metrics associated with the secondary source may not be directly indicative of the validity of the statements made by the primary source, which have been later relayed by the secondary source. Accordingly, in future embodiments, the system 300 may implement multiple layers of analysis, such that the system 300 may determine the validity of the underlying content (e.g., originating from the primary source) as relayed by the secondary source.

In an embodiment, the system 300 may be configured to analyze logical consistency of media content from a single source over an extended period of time. The logic-structure evaluation module may process a series of content items, such as articles, speeches, or social media posts, from the same author or organization across a predetermined timeframe. By comparing the logical structures, premises, and conclusions identified in each piece of content, the system 300 may detect and quantify logical inconsistencies that emerge over time. This analysis may generate a temporal consistency score, which reflects the degree to which the source maintains logical coherence across different time points. The temporal consistency score may be integrated with the combined integrity score to produce a longitudinal integrity assessment. This assessment may provide valuable insights into the evolution of a source's logical consistency and credibility over time.

Moreover, the system 300 may display this longitudinal assessment to the user via the one or more client devices 102-106, potentially including interactive visualizations that show how logical consistency changes over the analyzed period. Such temporal analysis may be particularly useful for evaluating the long-term reliability of news sources, tracking shifts in political rhetoric, or assessing the consistency of corporate communications over time.

In an embodiment, the system 300 may leverage quantum computing technologies to enhance its analytical capabilities, particularly in processing complex logical structures and performing sentiment analysis on large-scale datasets. Quantum computers, with their ability to perform certain computations exponentially faster than classical computers, may offer significant advantages in tackling the combinatorial complexity inherent in natural language processing and logical analysis.

In one implementation, the system 300 may utilize quantum annealing algorithms, such as those available on D-Wave quantum annealers, to optimize the graph-based representation of argument structures. This approach may allow for more efficient identification of key premises and conclusions within highly interconnected logical frameworks. Additionally, quantum-inspired algorithms running on classical hardware, such as the quantum approximate optimization algorithm (QAOA), may be employed to improve the performance of clustering and classification tasks within the sentiment analysis and logical coherence scoring modules. These quantum and quantum-inspired methods may enable the system 300 to handle increasingly complex and nuanced media content, potentially uncovering subtle logical relationships and emotional undertones that might be missed by purely classical approaches.

The following Examples demonstrate nonlimiting examples of the methods and protocols described herein.

Example 1. A non-transitory computer-readable medium storing instructions that, when executed by a processor, cause a system to perform a method for analyzing media content, the method comprising:
ingesting, via one or more web scraping techniques, media content from one or more online sources;
preprocessing, via one or more natural language processing tools, the media content comprising the steps of:
tokenizing the media content into a plurality of components,
removing stop words from the plurality of components,
lemmatizing the plurality of components, and
normalizing the plurality of components;
analyzing, via the one or more natural language processing tools, the preprocessed media content for one or more sentiments;
generating, via one or more scoring algorithms, a score for each of the one or more sentiments;
compiling the score for each of the one or more sentiments to generate a final score; and
displaying the final score on one or more client devices.

Example 2. The non-transitory computer-readable medium of Example 1, wherein the one or more natural language processing tools are comprised of at least one of NLTK and spaCy.

Example 3. The non-transitory computer-readable medium of Example 1, wherein the one or more web scraping techniques include Python-based scraping tools.

Example 4. The non-transitory computer-readable medium of Example 1, wherein the one or more web scraping techniques include JavaScript-based scraping tools.

Example 5. The non-transitory computer-readable medium of Example 1, wherein the method further comprises:
performing, via the one or more natural language processing tools, semantic analysis on the preprocessed media content.

Example 6. The non-transitory computer-readable medium of Example 1, wherein the method further comprises:
normalizing, via one or more statistical analysis libraries, the score for each of the one or more sentiments.

Example 7. The non-transitory computer-readable medium of Example 6, wherein the one or more statistical analysis libraries are comprised of Python libraries including pandas, NumPy, SciPy, and SQLAlchemy.

Example 8. The non-transitory computer-readable medium of Example 1, wherein compiling the score for each of the one or more sentiments is accomplished via one or more database management systems.

Example 9. A non-transitory computer-readable medium storing instructions that, when executed by a processor, cause a system to perform a method for analyzing audio content, the method comprising:
ingesting, via one or more web scraping techniques, audio content from one or more online sources;
preprocessing, the audio content comprising the steps of:
filtering background noise out of the audio content,
segmenting the filtered audio content into a plurality of segments,
transcribing the plurality of segments into text,
tokenizing the text into a plurality of components,
removing stop words from the plurality of components,
lemmatizing the plurality of components, and
normalizing the plurality of components;
analyzing, via one or more natural language processing tools, the preprocessed audio content for one or more sentiments;
generating, via one or more scoring algorithms, a score for each of the one or more sentiments;
compiling the score for each of the one or more sentiments to generate a final score; and
displaying the final score on one or more client devices.

Example 10. The non-transitory computer-readable medium of Example 9, wherein the one or more natural language processing tools are comprised of at least one of NLTK and spaCy.

Example 11. The non-transitory computer-readable medium of Example 9, wherein the one or more web scraping techniques include Python-based scraping tools.

Example 12. The non-transitory computer-readable medium of Example 9, wherein the one or more web scraping techniques include JavaScript-based scraping tools.

Example 13. The non-transitory computer-readable medium of Example 9, wherein the method further comprises:
performing, via the one or more natural language processing tools, semantic analysis on the preprocessed audio content.

Example 14. The non-transitory computer-readable medium of Example 9, wherein the method further comprises:
normalizing, via one or more statistical analysis libraries, the score for each of the one or more sentiments.

Example 15. The non-transitory computer-readable medium of Example 14, wherein the one or more statistical analysis libraries are comprised of Python libraries including pandas, NumPy, SciPy, and SQLAlchemy.

Example 16. The non-transitory computer-readable medium of Example 9, wherein compiling the score for each of the one or more sentiments is accomplished via one or more database management systems.

Example 17. The non-transitory computer-readable medium of Example 9, wherein transcribing the plurality of segments into text is accomplished via at least one of Google Speech-to-Text and IBM Watson Speech to Text.

Example 18. A non-transitory computer-readable medium storing instructions that, when executed by a processor, cause a system to perform a method for analyzing media content, the method comprising:
ingesting, via one or more web scraping techniques, media content from one or more online sources;
preprocessing, via one or more natural language processing tools, the media content comprising the steps of:
tokenizing the media content into a plurality of components,
removing stop words from the plurality of components,
lemmatizing the plurality of components, and
normalizing the plurality of components;
analyzing, via the one or more natural language processing tools, the preprocessed media content for one or more sentiments;
evaluating, via a logic-structure evaluation module, the preprocessed media content to identify premises, conclusions, and inferential transitions;
computing a logical coherence score based on structural consistency and alignment with formal logic schemas;
generating, via one or more scoring algorithms, a sentiment score for the one or more sentiments;
integrating the logical coherence score and the sentiment score to produce a combined integrity score;
generating a visualization of the analyzed media content,
wherein the visualization may include at least one of a logic graph and a breakdown of emotional and logical content; and
displaying the combined integrity score and the visualization on one or more client devices.

Example 19. The non-transitory computer-readable medium of Example 18, wherein evaluating the preprocessed media content via the logic-structure evaluation module comprises: employing a combination of rule-based systems and machine learning models, wherein the machine learning models include at least one of discourse marker analysis, syntactic parsing, semantic role labeling, coreference resolution, argument mining, sequence labeling, and transformer-based models; and
constructing a graph representation of an argument structure, wherein nodes represent statements and edges represent logical relationships.

Example 20. The non-transitory computer-readable medium of Example 18, wherein the method further comprises:
analyzing, via the logic-structure evaluation module, a series of media content from a single source over a predetermined time period;
identifying logical inconsistencies within the series of media content by comparing logical structures and conclusions across different time points;
generating a temporal consistency score that quantifies the degree of logical consistency and inconsistency over the predetermined time period;
integrating the temporal consistency score with the combined integrity score to produce a longitudinal integrity assessment; and
displaying the longitudinal integrity assessment on the one or more client devices, including a visualization of how logical consistency changes over time.

Example 21: A system configured to practice the protocols of any of the non-transitory computer-readable mediums in any of Examples 1-20.

Example 22: A computer-implemented method configured to execute the protocols of any of the non-transitory computer-readable mediums in any of Examples 1-20.

Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

Various elements, which are described herein in the context of one or more embodiments, may be provided separately or in any suitable subcombination. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

All references, patents and patent applications and publications that are cited or referred to in this application are incorporated in their entirety herein by reference. Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A non-transitory computer-readable medium storing instructions that, when executed by a processor, cause a system to perform a method for analyzing media content, the method comprising:
ingesting, via one or more web scraping techniques, media content from one or more online sources;
preprocessing, via one or more natural language processing tools, the media content comprising the steps of:
tokenizing the media content into a plurality of components,
removing stop words from the plurality of components,
lemmatizing the plurality of components, and
normalizing the plurality of components;
analyzing, via the one or more natural language processing tools, the preprocessed media content for one or more sentiments;
generating, via one or more scoring algorithms, a score for each of the one or more sentiments;
compiling the score for each of the one or more sentiments to generate a final score; and
displaying the final score on one or more client devices.

2. The non-transitory computer-readable medium of claim 1, wherein the one or more natural language processing tools are comprised of at least one of NLTK and spaCy.

3. The non-transitory computer-readable medium of claim 1, wherein the one or more web scraping techniques include Python-based scraping tools.

4. The non-transitory computer-readable medium of claim 1, wherein the one or more web scraping techniques include JavaScript-based scraping tools.

5. The non-transitory computer-readable medium of claim 1, wherein the method further comprises:
performing, via the one or more natural language processing tools, semantic analysis on the preprocessed media content.

6. The non-transitory computer-readable medium of claim 1, wherein the method further comprises:
normalizing, via one or more statistical analysis libraries, the score for each of the one or more sentiments.

7. The non-transitory computer-readable medium of claim 6, wherein the one or more statistical analysis libraries are comprised of Python libraries including pandas, NumPy, SciPy, and SQLAlchemy.

8. The non-transitory computer-readable medium of claim 1, wherein compiling the score for each of the one or more sentiments is accomplished via one or more database management systems.

9. A non-transitory computer-readable medium storing instructions that, when executed by a processor, cause a system to perform a method for analyzing audio content, the method comprising:
ingesting, via one or more web scraping techniques, audio content from one or more online sources;
preprocessing, the audio content comprising the steps of:
filtering background noise out of the audio content,
segmenting the filtered audio content into a plurality of segments,
transcribing the plurality of segments into text,
tokenizing the text into a plurality of components,
removing stop words from the plurality of components,
lemmatizing the plurality of components, and
normalizing the plurality of components;
analyzing, via one or more natural language processing tools, the preprocessed audio content for one or more sentiments;
generating, via one or more scoring algorithms, a score for each of the one or more sentiments;
compiling the score for each of the one or more sentiments to generate a final score; and
displaying the final score on one or more client devices.

10. The non-transitory computer-readable medium of claim 9, wherein the one or more natural language processing tools are comprised of at least one of NLTK and spaCy.

11. The non-transitory computer-readable medium of claim 9, wherein the one or more web scraping techniques include Python-based scraping tools.

12. The non-transitory computer-readable medium of claim 9, wherein the one or more web scraping techniques include JavaScript-based scraping tools.

13. The non-transitory computer-readable medium of claim 9, wherein the method further comprises:
performing, via the one or more natural language processing tools, semantic analysis on the preprocessed audio content.

14. The non-transitory computer-readable medium of claim 9, wherein the method further comprises:
normalizing, via one or more statistical analysis libraries, the score for each of the one or more sentiments.

15. The non-transitory computer-readable medium of claim 14, wherein the one or more statistical analysis libraries are comprised of Python libraries including pandas, NumPy, SciPy, and SQLAlchemy.

16. The non-transitory computer-readable medium of claim 9, wherein compiling the score for each of the one or more sentiments is accomplished via one or more database management systems.

17. The non-transitory computer-readable medium of claim 9, wherein transcribing the plurality of segments into text is accomplished via at least one of Google Speech-to-Text and IBM Watson Speech to Text.

18. A non-transitory computer-readable medium storing instructions that, when executed by a processor, cause a system to perform a method for analyzing media content, the method comprising:
ingesting, via one or more web scraping techniques, media content from one or more online sources;
preprocessing, via one or more natural language processing tools, the media content comprising the steps of:
tokenizing the media content into a plurality of components,
removing stop words from the plurality of components,
lemmatizing the plurality of components, and
normalizing the plurality of components;
analyzing, via the one or more natural language processing tools, the preprocessed media content for one or more sentiments;
evaluating, via a logic-structure evaluation module, the preprocessed media content to identify premises, conclusions, and inferential transitions;
computing a logical coherence score based on structural consistency and alignment with formal logic schemas;
generating, via one or more scoring algorithms, a sentiment score for the one or more sentiments;
integrating the logical coherence score and the sentiment score to produce a combined integrity score;
generating a visualization of the analyzed media content,
wherein the visualization may include at least one of a logic graph and a breakdown of emotional and logical content; and
displaying the combined integrity score and the visualization on one or more client devices.

19. The non-transitory computer-readable medium of claim 18, wherein evaluating the preprocessed media content via the logic-structure evaluation module comprises:
employing a combination of rule-based systems and machine learning models, wherein the machine learning models include at least one of discourse marker analysis, syntactic parsing, semantic role labeling, coreference resolution, argument mining, sequence labeling, and transformer-based models; and
constructing a graph representation of an argument structure, wherein nodes represent statements and edges represent logical relationships.

20. The non-transitory computer-readable medium of claim 18, wherein the method further comprises:
analyzing, via the logic-structure evaluation module, a series of media content from a single source over a predetermined time period;
identifying logical inconsistencies within the series of media content by comparing logical structures and conclusions across different time points;
generating a temporal consistency score that quantifies the degree of logical consistency and inconsistency over the predetermined time period;
integrating the temporal consistency score with the combined integrity score to produce a longitudinal integrity assessment; and
displaying the longitudinal integrity assessment on the one or more client devices, including a visualization of how logical consistency changes over time.
